(19) United States
(12) Patent Application Publication
(10) Pub. No.: US 2005/0179273 A1
(43) Pub. Date: Aug. 18, 2005

(54) Pawl for move and catch machine

(76) Inventor: Yi-Chiang Yang, Chang Hua (TW)

Correspondence Address: CHARLES E. BAXLEY, ESQ., 90 JOHN STREET, THIRD FLOOR, NEW YORK, NY, 10038, US

(21) Appl. No.: 10/998,246

(22) Filed: Nov. 25, 2004

(30) Foreign Application Priority Data
Feb. 17, 2004 (TW) 093103808

(51) Int. Cl. B25J 15/08

(52) U.S. Cl. 294/88

(57) ABSTRACT

A pawl for a move and grab machine includes a connection plate and two grab arms are pivotably connected to tow ends of the connection plate. A rod is connected to a top of the connection plate and connected to an output shaft of a pneumatic cylinder located in a tubular member. The grab arms are pivoted to close toward each other to grab a doll by lifting the rod by the pneumatic cylinder. A spring is mounted to the output shaft so as to pull the output shaft to its normal position.

### FIELD OF THE INVENTION

The present invention relates to a pawl structure for a move and catch machine and the pawl is activated by a pneumatic cylinder so as to provide sufficient grab force.

### BACKGROUND OF THE INVENTION

A conventional move and catch machine is disclosed in FIG. 1 and generally includes a case 1 with a plurality of dolls randomly put in a space in the case 1 and a pawl 5 composed of pivotably connected grab arms is movably located at a ceiling of the space. The pawl 5 can be controlled by operating a control stick 3 and a button 4. A user operates the control stick 3 to move the pawl 5 along rails on the ceiling and the pawl 5 is lowered and grabs the dolls by pressing the button 4. The pawl 5 is activated by an electromagnetic valve 50 as shown in FIG. 2. How the pawl 5 grabs decides success of the grab for the dolls. However, when the dolls 2 are bulky and heavy, the pawl 5 has to be powerful so as to securely grab the dolls 2 till the dolls 2 are grabbed and moved to the position above the outlet. However, due to the heavy dolls 2, only a limited length of the shaft 40 that is connected to the link mechanism of the pawl 5 is inserted in the operation area in the electromagnetic valve 50 so that the pawl 5 cannot not completely opened so that it is difficult to catch a large doll.

The present invention intends to provide a pawl structure wherein the grab arms of the pawl is activated by a pneumatic cylinder so that the grab arms can be opened and closed completely.

### SUMMARY OF THE INVENTION

The present invention relates to a pawl for a move and grab machine, wherein the pawl comprises a connection plate with two grab arms pivotably connected to tow ends thereof and a rod is connected to a top of the connection plate so as to be connected to an output shaft of a pneumatic cylinder received in a tubular member. Two links each have a first end pivotably connected to lugs extending from the tubular member and two respective second ends of the two links are pivotably connected to the two grab arms. The grab arms can be completely opened wide and closed by the pneumatic cylinder.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional pawl in a move and grab machine;

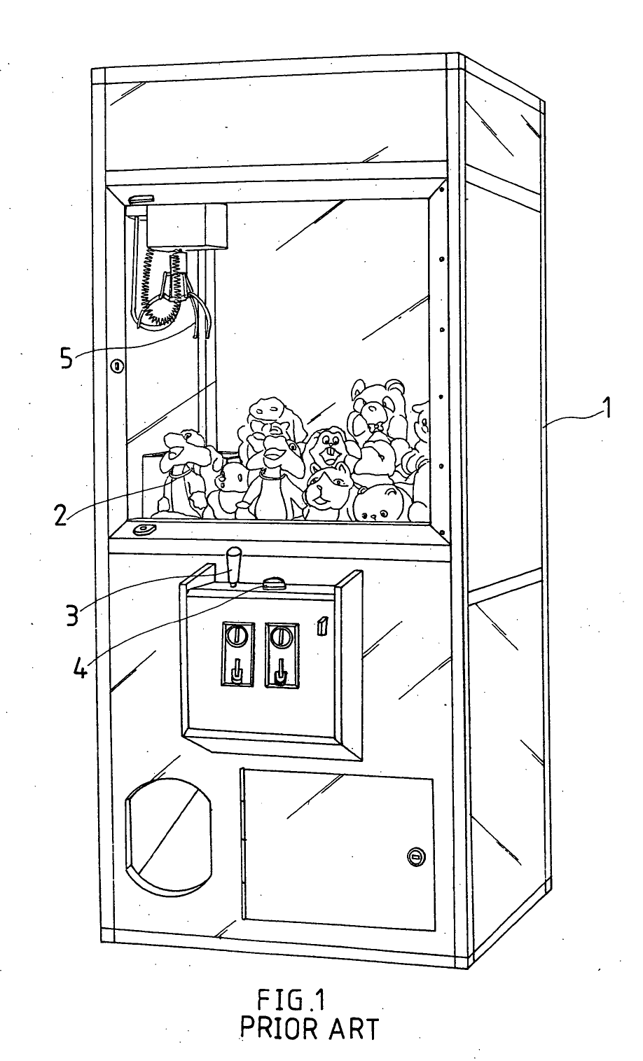

FIG. 2 shows a structure of the conventional pawl;

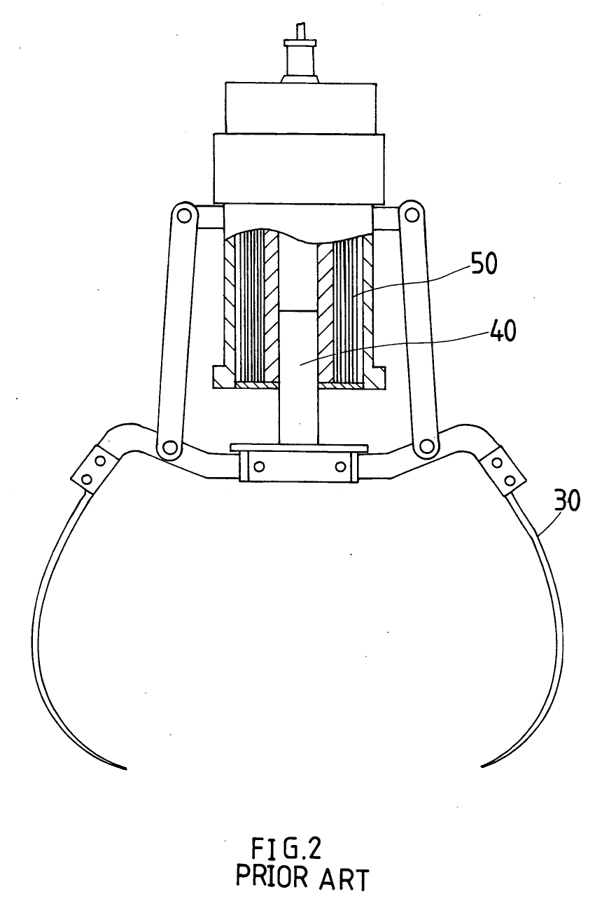

FIG. 3 shows the pawl of the present invention is used in a move and grab machine with larger dolls;

FIG. 4 is a cross sectional view to show the pawl of the present invention, and

FIG. 5 is a cross sectional view to show another embodiment of the pawl of the present invention.

### DETAILED DESCRIPTION OF THE PREFERRED EMBODIMENT

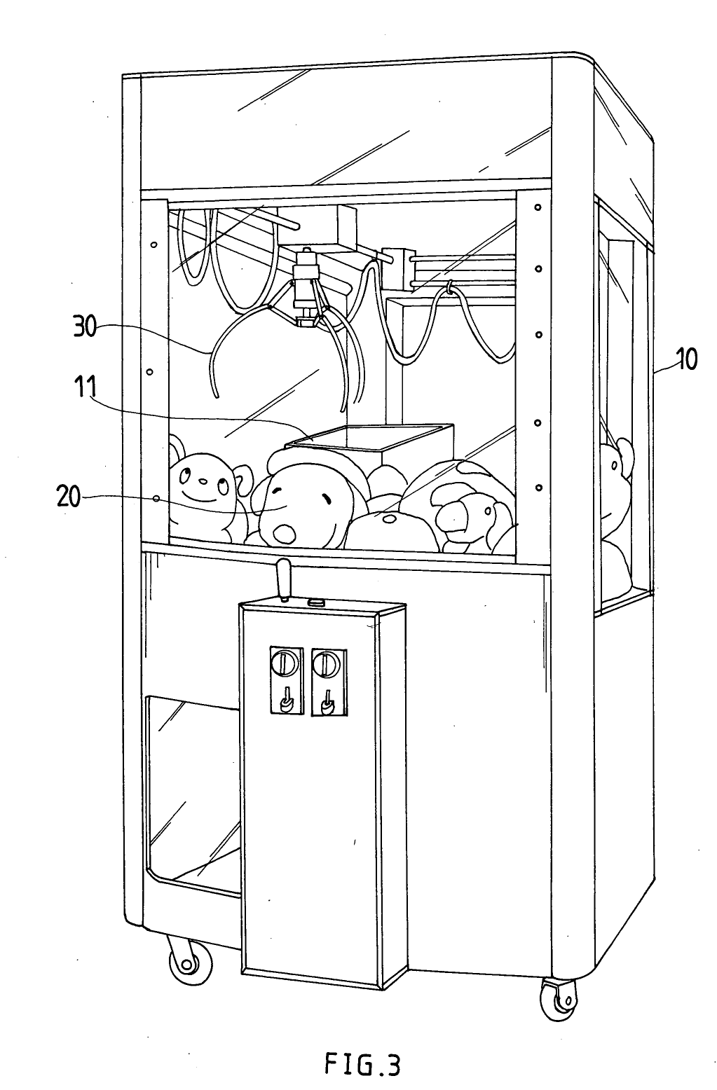

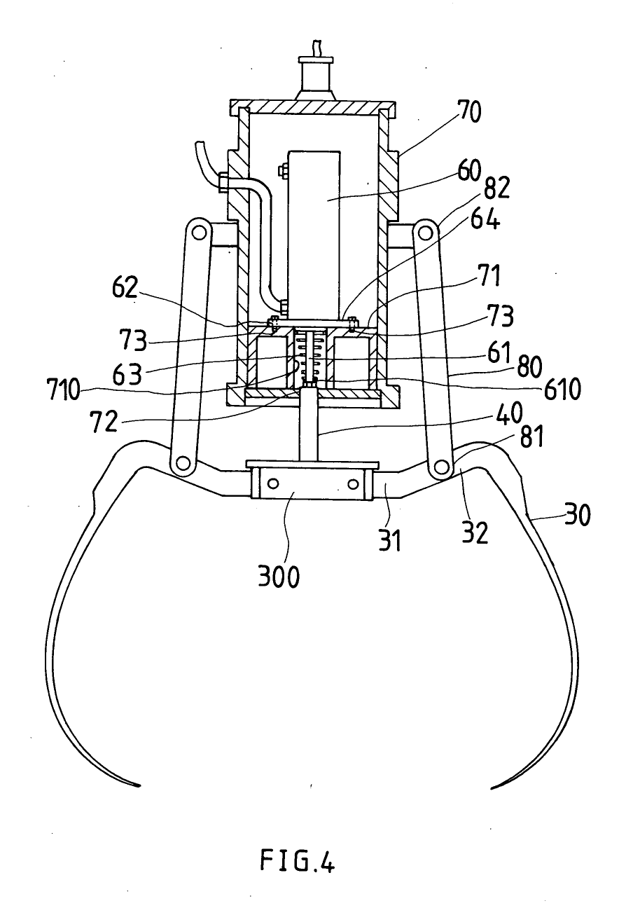

Referring to FIGS. 3 and 4, the pawl structure of the present invention used in a move grab machine 10 with larger dolls 20 comprises a connection plate 300 and two grab arms 30 are pivotably connected to tow ends of the connection plate 300. A rod 40 is connected to a top of the connection plate 300. A pneumatic cylinder 60 is received in a tubular member 70 and has an output shaft 61 which movably extends from an end thereof. The pneumatic cylinder 60 is securely positioned on a support member 71 in a lower end of the tubular member 70. The support member 71 has a passage 710 through which the output shaft 61 movably extends. A spring 63 is mounted to the output shaft 61 and biased between an end of the pneumatic cylinder 60 and a clip 610 mounted to the output shaft 61. An end board 64 is connected to the end of the pneumatic cylinder 60 and includes several through holes 62. The support member 71 has threaded recesses 73 so that bolts extend through the through holes 62 and are threadedly connected to the threaded recesses 73 to position the pneumatic cylinder 60 on the support member 71. A hole 72 is defined through a bottom of the support member 71 so that the rod 40 movably extends through the hole 72 and is connected to the output shaft 61.

Two links 80 each have a first end 82 pivotably connected to lugs extending from the tubular member 70 and two respective second ends 81 of the two links 80 are pivotably connected to a transverse portion 32 of the two grab arms 30. When the connection plate 300 is lifted by the pneumatic cylinder 60, the transverse portions 32 of the grab arms 30 are pivoted downward to perform a grab function to catch a doll 20 which is then moved to an outlet 11 and drop into the outlet 11. After the grabbing action is completed, the spring 63 pushes the output shaft 61 back its original position.

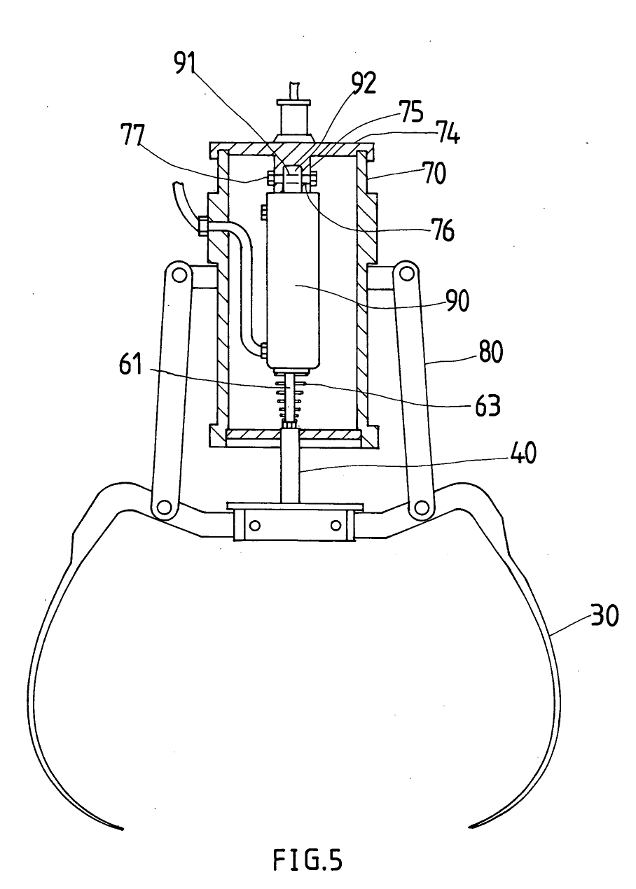

As shown FIG. 5, the positioning of the pneumatic cylinder 90 can be positioned as shown. A top cap 74 is connected to a top of the tubular member 70 and two extensions 75 extend from an inside of the top cap 74 and the pneumatic cylinder 90 has an insertion 92 on a top thereof. The insertion 92 includes a hole 91 and a pin 77 extends through two holes 76 in the two extensions 75 and the hole 91 in the insertion 92.

While we have shown and described the embodiment in accordance with the present invention, it should be clear to those skilled in the art that further embodiments may be made without departing from the scope of the present invention.

1. A pawl for a move and grab machine, comprising:
a connection plate and two grab arms pivotably connected to tow ends of the connection plate, a rod is connected to a top of the connection plate, and a pneumatic cylinder having an output shaft movably extending from an end thereof and connected to the rod, the pneumatic cylinder is received in a tubular member, two links each having a first end pivotably connected to lugs extending from the tubular member and two respective second ends of the two links pivotably connected to the two grab arms.

2. The pawl as claimed in claim 1, wherein the tubular member has a support member which has a passage through which the output shaft movably extends, a spring is mounted to the output shaft and biased between an end of the pneumatic cylinder and a clip mounted to the output shaft.

3. The pawl as claimed in claim 2, wherein an end board is connected to the end of the pneumatic cylinder and includes several through holes, the support member having threaded recesses so that bolts extend through the through holes and threadedly connected to the threaded recesses.

4. The pawl as claimed in claim 1, wherein two extensions extend from an inside of the tubular member and the pneumatic cylinder has an insertion on a top thereof, the insertion includes a hole and a pin extends through two holes in the two extensions and the hole in the insertion.
